(19) United States
(12) Patent Application Publication
(10) Pub. No.: US 2014/0324466 A1
(43) Pub. Date: Oct. 30, 2014

(54) SYSTEM AND PROCESS FOR REAL-TIME ELECTRONIC MEDICAL RECORDS LOSS EXPOSURE INCIDENT DATA ACQUISITION AND PREDICTIVE ANALYTICS INSURANCE LOSS CONTROL REPORTING

(71) Applicant: DAVID JOHN WERTZBERGER, Reno, NV (US)

(72) Inventor: DAVID JOHN WERTZBERGER, Reno, NV (US)

(21) Appl. No.: 14/261,950

(22) Filed: Apr. 25, 2014

Related U.S. Application Data
(60) Provisional application No. 61/816,577, filed on Apr. 26, 2013.

(51) Int. Cl. G06F 19/00

(52) U.S. Cl. CPC G06F 19/328; G06F 19/327; G06F 19/322
USPC 705/3; 705/2

(57) ABSTRACT

Real-time electronic medical loss exposure incident records data acquisition system and process for predictive analytics insurance loss control reporting direct to insured policy holder is disclosed. Electronic loss exposure information from a facility, in real-time, is input to insurance predictive analytics models that predict probability of increased loss exposure and deliver notifications to facility management immediately and independent of human interaction.

### CLAIM OF BENEFIT TO PRIOR APPLICATION

This application claims benefit to U.S. Provisional Patent Application 61/816,577, entitled “REAL-TIME ELECTRONIC MEDICAL RECORDS DATA ACQUISITION FOR PREDICTIVE ANALYTICS INSURANCE LOSS CONTROL REPORTING,” filed Apr. 26, 2013. The U.S. Provisional Patent Application 61/816,577 is incorporated herein by reference.

### BACKGROUND

Embodiments of the invention described in this specification relate generally to resident or patient activity analysis, and more particularly, to predictive analytics for loss exposure reporting.

Owners of health care facilities have exposure to loss and risk but do not have proactive analytic tools to develop remediation plans. Conventional systems are reactive in nature as events happens and are not proactive in nature with regard to anticipating future events based on prior history. Conventional systems and approaches do not incorporate insurance industry loss history into proactive remedial loss control action and thus many opportunities to prevent events or losses are not exploited.

Electronic medical records (EMR) systems provide feedback on all activities, yet the conventional systems fail to provide management feedback of known insurance industry claims incidents and actual losses on a routine or daily basis, when opportunities to prevent events or losses may be realized.

Therefore, improvements to conventional systems to incorporate the acquisition and utilization of loss exposure data for a facility or a group of related facilities in order to reduce potential future losses and loss exposure are desirable. In particular, what is needed is a system that utilizes electronic loss exposure information from a facility, in real-time, as input to insurance predictive analytics models that predict probability of increased loss exposure and deliver real-time notifications to facility management and other interested parties immediately and independent of human interaction.

### BRIEF DESCRIPTION

Some embodiments of the invention include a novel system that utilizes electronic loss exposure information from a facility, in real-time, as input to insurance predictive analytics models that predict probability of increased loss exposure and deliver notifications to facility management immediately and independent of human interaction. In some embodiments of the system, privatized patient EMR data acquisition from a computer or electronic device is transmitted electronically to an insurance company or service organization for real-time predictive analytics analysis and is used to provide feedback to facility management with proactive recommendations to reduce risk and loss exposure with regard to patients and with regard to worker's work environment.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a block diagram of a real-time electronic medical records data acquisition system used in predictive analytics insurance loss control reporting in some embodiments.

FIG. 2 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

As stated above, owners of health care facilities have exposure to loss and risk but do not currently have proactive analytic tools to develop remediation plans and improve existing and/or best practices. Embodiments of the invention described in this specification solve such problems by a novel system that utilizes electronic loss exposure information from a facility, in real-time, as input to insurance predictive analytics models that predict probability of increased loss exposure and deliver notifications to facility management immediately and independent of human interaction. In some embodiments of the system, privatized patient EMR data acquisition from a computer or electronic device is transmitted electronically to an insurance company or service organization for real-time predictive analytics analysis and is used to provide feedback to facility management with proactive recommendations to reduce risk and loss exposure with regard to patients and with regard to worker's work environment.

The embodiments described in this specification differ from and improve upon currently existing options. In particular, some embodiments of the system differ because current practices and procedures are manual and dependent on human analysis of risk and exposure to loss. Such systems and/or approaches to analysis of such data are fraught with potential bias and subjective analysis by the individual(s) performing the analysis. Moreover, these systems and/or approaches do not incorporate actual exposure information from the insurance industry.

In addition, some embodiments of the system improve upon the currently existing systems by increasing the speed at which analysis and reporting is completed. In current systems, the speed of analysis and return of suggested remedial or preventive actions does not permit full utilization of the power of the predictive analytics process by the owners or operators of the facilities being monitored. Also, typically, the data reviewed is limited to information only about the facility being monitored and does not bring in real-time or up-to-date information about peer facilities that may be unrelated to the facility being monitored. The information from peer institutions may provide great benefit in understanding how others have addressed the same or similar problems and may provide some prediction of future issues based on the experiences of other facilities, either locally or nationwide.

Without loss history from other facilities or from the insurance industry as a whole, a facility is limited to its own limited history. This may result in decisions being made based on a reduced knowledge base of loss exposure probability. Further, most facilities review exposure to loss in an annual audit or monthly safety meeting. More frequent or real-time review and analysis, along with development or recognition of possible remedial or preventive measures may result reductions to loss events and loss exposure for a facility.

In the system of some embodiments, electronic loss exposure information from a facility, in real-time, may be input to insurance predictive analytics models that predict probability of increased loss exposure and deliver notifications to facility management immediately and independent of human interaction or biases. The information can be analyzed in real-time and does not require the convening of a committee or loss prevention group meeting to review the information and develop appropriate actions. With this system, the analysis may produce real-time electronic alerts in email and/or to a smart mobile device, such as a cell phone or tablet computing device in addition to a loss exposure report for a facility to be proactive in managing risk exposure for both workers and patients.

The system of the present disclosure may be comprised of the following elements. This list of possible constituent elements is intended to be exemplary only and it is not intended that this list be used to limit the system of the present application to just these elements. Persons having ordinary skill in the art relevant to the present disclosure may understand there to be equivalent elements that may be substituted within the present disclosure without changing the essential function or operation of the system.

1. Electronic Medical Records (EMR) data for a particular facility or associated group of facilities (e.g., by transmission of the EMR data by connecting facility EMR system to insurance provider analytics system).

2. Privatized Data received by insurance provider regarding patients from other facilities corresponding to the facilities from which the EMR data is drawn.

3. A Predictive Analytics tool to permit correlation and analysis of EMR data and the privatized data (e.g., an insurance provider analytics model that computes the probability of increased exposure based on insurance industry incidents—what is the probability of loss?).

4. Real-time alerts and loss exposure report electronic delivery to facility or group of associated facilities (e.g., report highlighting increased loss exposure which is then communicated to facility management).

In operation, the electronic medical records data may be captured in real-time for immediate predictive analytics modeling, compared to historical database for delivery of Loss Exposure probability to facility management. Updates to the information utilized for the operation of the system of the present application may be provided in real-time, as updates are inserted into the EMR that might impact the loss prevention equation, updated on a short time-window periodic basis (hourly, four times daily, twice daily, daily, etc.) or on an ad hoc basis when it is determined that an effort at loss prevention should be initiated or revised.

The predictive analytics model utilized in the system of the present application may process facility data using quantified input from all or a subset of insurance industry loss history and loss control specialists. Slices through the data may be based on specific facility type, operational models for facilities, primary characteristics of patients treated, historical loss characteristics, location, size, etc. Multiple analytical runs may be made for a facility based on multiple sets or subsets of data from the insurance industry and/or from loss control specialists. The predictive models learn from the loss history database to deliver increasing levels of accuracy in predicting loss exposure and risk probability for facility operations. If analysis for a particular facility indicates an undesirably large risk or potential increased exposure to an excessive large loss, warnings, electronic alerts, and/or reports may be sent to facility management immediately.

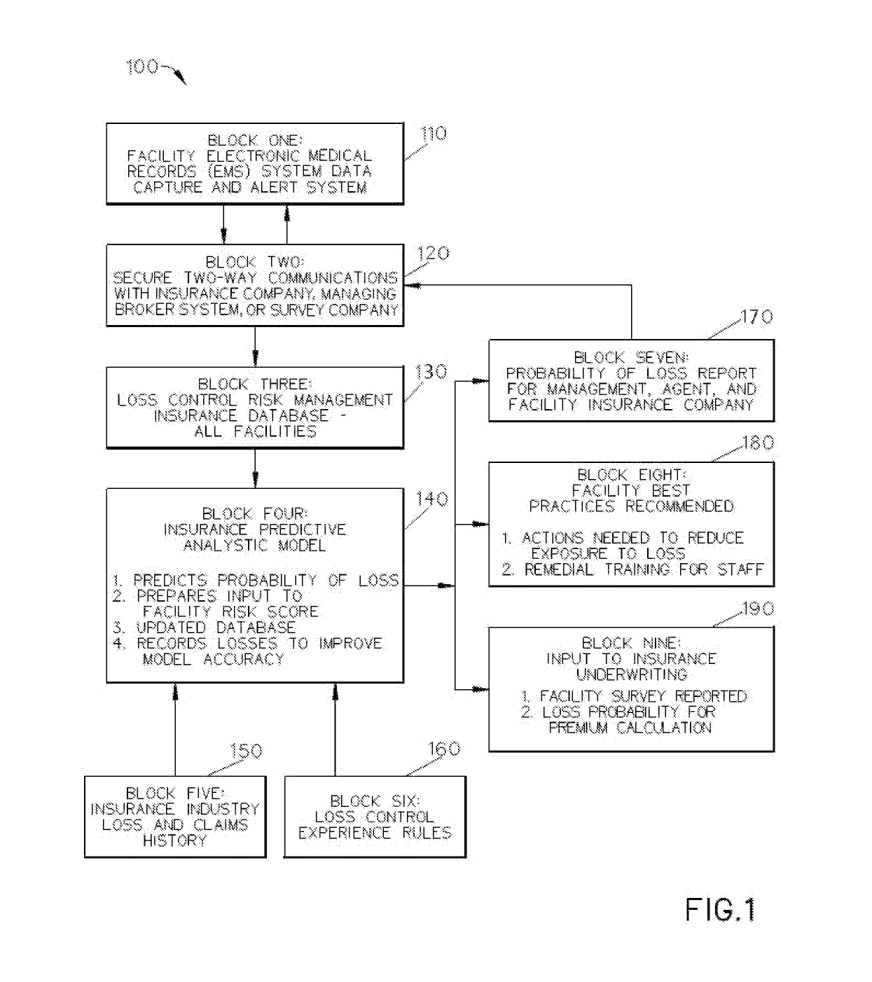

By way of example, FIG. 1 conceptually illustrates a block diagram of a real-time electronic medical records data acquisition system used in predictive analytics insurance loss control reporting in some embodiments. As shown in this figure, the system 100 performs a process in which a plurality of operations are performed. Specifically, in block one 110, the process captures EMR data of a facility. In block two 120, the process secures two-way communication with the insurance provider or servicing company (or managing broker system, if any). A loss control risk management insurance database is shown in block three 130. The process of some embodiments stores data in the database after the initial EMR data capture and during application of the predictive analytics insurance model.

Next, in block four 140, the EMR data is processed by the insurance predictive analytics model, which (1) predicts the probability of loss, (2) computes input to facility risk score, (3) updates the database, and (4) records losses to improve the predictive model's accuracy. As shown in block five 150, the process feeds insurance industry loss and claims historical data to the insurance predictive analytic model (at block four 140). Similarly, in block six 160, the process provides a set of loss control experience rules to the insurance predictive analytic model in block four 140.

After application of the insurance predictive analytic model at block four 140, the process then proceeds to block seven 170 to prepare a report with the results of the predictive model. Specifically, the report generated includes a probability of loss and computed risk score which management, insurance agents, and/or the facility insurance company can review.

At block eight 180, the process includes recommendations for facility best practices. The recommendations provided by way of the process include, without limitation, (1) actions needed to reduce exposure to loss and (2) remedial training that may be implemented for staff. Also, at block nine 190, the process provides information for insurance underwriting, including, without limitation, (1) the facility risk score reported and (2) the loss probability for premium calculations. Although the steps of the process described by reference to blocks seven 170 through nine 190 are discussed in a particular order, in some cases, the order of these steps (i.e., the process steps performed in block seven 170, block eight 180, and block nine 190) may occur in any order.

Different facilities, or the owners/operators of different facilities, may have different acceptable risk profiles and it is desirable that the system of the present application be able to quantify the absolute risk levels and then apply different filters to those absolute results to determine whether any sort of warning or computed risk score should be transmitted regarding a particular facility. It is also anticipated that regulatory requirements may have an impact on acceptable risk profiles and various local, state, regional or federal requirements may be built into the reporting side of the system to ensure compliance with relevant laws and regulations.

In operation of the system of the present application, the EMR data utilized would preferably be privatized to meet HIPPA requirements and transmitted to insurance company data processing operations or service company. Insurance industry claims, losses and incidents may be stored in a Loss Control database along with loss control rules. Loss control rules may be developed from the experience of loss control consultants. Predictive analytics mathematical models may be used to analyze real-time facility EMR data along with loss control database information to predict probability of loss for worker safety and patient care. Repetitive behavior analytics may be incorporated to provide facility owners/operators with recommendations for remedial training to improve best practices in a facility. This remedial training may be with regard to medical services, administrative operations, general worker safety, facility maintenance, or any other appropriate functions undertaken by the facility that may be indicated as needing improvement to reduce the risk of loss.

It is anticipated that the addition or utilization of data derived directly from biosensors may be used by the analytical tools as part of the predictive analysis to improve the accuracy of the analytics, such as but not limited to worker exposure to risky tasks to reduce injuries, or monitoring of patients care operations for possible stress to workers or patients.

To utilize the system of the present application, a facility owner may need an electronic medical records software system and a contract with an insurance company who has built a database and analytics models for processing of the real-time data. The system may be operated as a standalone tool that may be used to analyze different sets of facility data against different appropriate databases from insurance industry data that may be selected with regard to the facility being analyzed, or the system may be customized to work with a particular database from insurance industry data and apply all facility data against that same database. The system may be configured as a tool that is provided to a facility for measuring their particular facility data against whatever industry database that they can develop or procure. The system may be operated as a service or may be sold as a tool for use by others.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors), they cause the processing unit(s) to perform the actions indicated in the instructions. Examples of computer readable media include, but are not limited to, CD-ROMs, flash drives, RAM chips, hard drives, EPROMs, EEPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

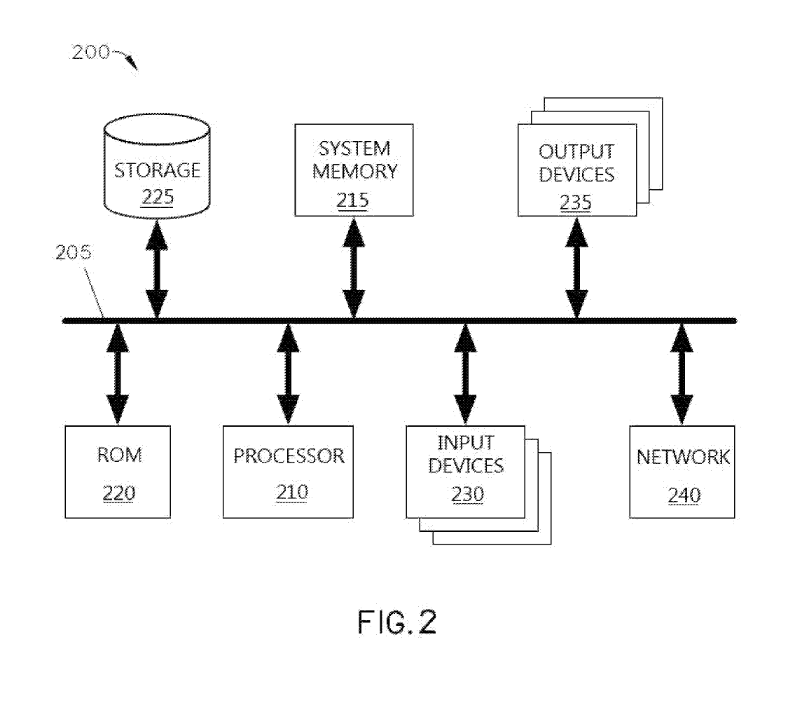

FIG. 2 conceptually illustrates an electronic system 200 with which some embodiments of the invention are implemented. The electronic system 200 may be a computing device, such as a desktop computer, a laptop computer, a tablet computing device, a portable hand-held computing device, a portable communications devices (such as a mobile phone), a personal digital assistant (PDA) computing device, or any other sort of electronic device. Such an electronic system includes various types of computer readable media and interfaces for various other types of computer readable media. Electronic system 200 includes a bus 205, processing unit(s) 210, a system memory 215, a read-only 220, a permanent storage device 225, input devices 230, output devices 235, and a network 240.

The bus 205 collectively represents all system, peripheral, and chipset buses that communicatively connect the numerous internal devices of the electronic system 200. For instance, the bus 205 communicatively connects the processing unit(s) 210 with the read-only 220, the system memory 215, and the permanent storage device 225.

From these various memory units, the processing unit(s) 210 retrieves instructions to execute and data to process in order to execute the processes of the invention. The processing unit(s) may be a single processor or a multi-core processor in different embodiments.

The read-only-memory (ROM) 220 stores static data and instructions that are needed by the processing unit(s) 210 and other modules of the electronic system. The permanent storage device 225, on the other hand, is a read-and-write memory device. This device is a non-volatile memory unit that stores instructions and data even when the electronic system 200 is off. Some embodiments of the invention use a mass-storage device (such as a magnetic or optical disk and its corresponding disk drive) as the permanent storage device 225.

Other embodiments use a removable storage device (such as a floppy disk or a flash drive) as the permanent storage device 225. Like the permanent storage device 225, the system memory 215 is a read-and-write memory device. However, unlike storage device 225, the system memory 215 is a volatile read-and-write memory, such as a random access memory. The system memory 215 stores some of the instructions and data that the processor needs at runtime. In some embodiments, the invention's processes are stored in the system memory 215, the permanent storage device 225, and/or the read-only 220. For example, the various memory units include instructions for processing appearance alterations of displayable characters in accordance with some embodiments. From these various memory units, the processing unit(s) 210 retrieves instructions to execute and data to process in order to execute the processes of some embodiments.

The bus 205 also connects to the input and output devices 230 and 235. The input devices enable the user to communicate information and select commands to the electronic system. The input devices 230 include alphanumeric keyboards and pointing devices (also called “cursor control devices”). The output devices 235 display images generated by the electronic system 200. The output devices 235 include printers and display devices, such as cathode ray tubes (CRT) or liquid crystal displays (LCD). Some embodiments include devices such as a touchscreen that functions as both input and output devices.

Finally, as shown in FIG. 2, bus 205 also couples electronic system 200 to a network 240 through a network adapter (not shown). In this manner, the computer can be a part of a network of computers (such as a local area network (“LAN”), a wide area network (“WAN”), or an Intranet), or a network of networks (such as the Internet) including personal smart mobile computing and/or communication devices such as a cell phone or a tablet computing device. Any or all components of electronic system 200 may be used in conjunction with the invention.

The functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIG. 1 conceptually illustrates steps of a process. The specific operations of this process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details and examples, but rather is to be defined by the appended claims.

I claim:

1. A non-transitory computer readable medium storing a program which, when executed by at least one processing unit of a computing device, performs real-time electronic medical records (EMR) data acquisition for predictive analytics insurance loss control reporting, said program comprising sets of instructions for:
receiving a set of electronic loss exposure data from a facility;
using the set of electronic loss exposure data as input to an insurance predictive analytics model that predicts probability of increased loss exposure;
applying the insurance predictive analytics model to predict probability of increased loss exposure;
generating a report of the predicted probability of increased loss exposure and a computed risk score for facility management to review; and
providing routine electronic real-time notifications of increased loss exposure to facility management immediately and independent of human interaction.

2. The non-transitory computer readable medium of claim 1, wherein the received a set of electronic loss exposure data from the facility comprises patient EMR data.

3. The non-transitory computer readable medium of claim 1, wherein the program further comprises a set of instructions for providing feedback to facility management.

4. The non-transitory computer readable medium of claim 3, wherein the set of instructions for providing feedback comprises a set of instructions for providing recommendations to reduce risk and loss exposure.

5. The non-transitory computer readable medium of claim 4, wherein the recommendations to reduce risk and loss exposure pertain to patient risk and loss exposure reduction.

6. The non-transitory computer readable medium of claim 4, wherein the recommendations to reduce risk and loss exposure pertain to work environment risk and loss exposure reduction.

7. A system that utilizes electronic loss exposure data from a facility, in real-time, as input to an insurance predictive analytics model that predicts probability of increased loss exposure and delivers notifications to facility management immediately and independent of human interaction, said system comprising:
an electronic medical records (EMR) system of a facility that maintains EMR data for the facility;
an insurance provider analytics system that receives the facility EMR data from the facility;
a predictive analytics tool that correlates and analyzes the EMR data to compute the probability of increased exposure based on insurance industry incidents; and
a loss exposure report electronic delivery system to (i) generate reports including the loss exposure probability and peer facility comparison computed by the predictive analytics tool and (ii) provide the reports in real-time to facility management.

8. The system of claim 7, wherein the facility comprises a group of associated facilities.

9. The system of claim 7, wherein said EMR system of the facility comprises a database and a database management system that stores the EMR data in the database.

10. The system of claim 7, wherein said EMR system of the facility comprises a computing device that retrieves the EMR data from the database and transmits the EMR data to the insurance provider analytics system.
